(19) United States
(12) Patent Application Publication
(10) Pub. No.: US 2015/0174686 A1
(43) Pub. Date: Jun. 25, 2015

(54) METHOD AND DEVICE FOR JOINING CONDUCTORS TO SUBSTRATES

(71) Applicant: Maschinenfabrik Reinhausen GmbH, Regensburg (DE)

(72) Inventor: Elshad Shirinov, Regensburg (DE)

(21) Appl. No.: 14/631,323

(22) Filed: Feb. 25, 2015

Related U.S. Application Data
(63) Continuation of application No. PCT/EP2013/067478, filed on Aug. 22, 2013.

(30) Foreign Application Priority Data
Aug. 28, 2012 (DE) 102012107896.3

(51) Int. Cl. B23K 10/02; B23K 1/012

(52) U.S. Cl. CPC B23K 10/027; B23K 1/012

(57) ABSTRACT

The present invention relates to a method and a device (1) for joining conductors (10) to substrates (20). The device (1) comprises at least one positioning unit (40) which positions a conductor (10) in a section (33) to be connected on or near the substrate (20). A plasma (51) is generated in at least one plasma source (50). At least one feed line (55) serves for feeding a connecting material (30) into the plasma (51) of the plasma source (50). Furthermore, a plurality of devices (1) according to the present invention can be combined in a system which is designed for the parallel processing of one or a plurality of substrates (20).

### CROSS REFERENCE TO RELATED APPLICATIONS

This application is filed under 35 U.S.C. §111(a) and §365(c) as a continuation of International Patent Application PCT/EP2013/067478, filed on Aug. 22, 2013, which application claims priority from German Patent Application No. DE 10 2012 107 896.3, filed on Aug. 28, 2012, which applications are incorporated herein by reference in their entireties.

### FIELD OF THE INVENTION

The present invention relates to a method and device for joining conductors to substrates. Furthermore, plural devices according to the present invention can be integrated within a system configured for processing one or plural substrates in parallel.

### BACKGROUND OF THE INVENTION

For joining metal work-pieces, various thermal joining methods are used in industrial manufacturing, for example in the car, shipbuilding or aircraft industry. Known joining methods include gas metal arc soldering (GMAS), laser soldering, induction soldering, plasma soldering, plasma powder soldering, or plasma powder surfacing by soldering. In these soldering methods usually a connecting material in the form of powder, filler wire, or wire is melted. The molten connecting material can form a metallurgical solder connection with the metal work pieces by diffusion or welding of the interfaces and in this way joins them. In the soldering process the metal work pieces need not be melted or need to be melted only partially.

In plasma powder surfacing by soldering, for example, a metal powder from a hard substance reinforced Al base material is applied on an Al base substrate in order to increase the wear resistance of the surface of the substrate. Also known are thermal spraying methods like plasma spraying using powders in atmosphere or vacuum, flame spraying using wires or powders, arc spraying with wire or filler wire, high speed flame spraying with the powder.

German Patent No. DE 100 19 095 B4 discloses a method for thermal joining of metal parts by plasma powder soldering. A plasma jet is directed onto the metal parts to be joined from the plasma gun. Plasma gun and the metal parts to be joined are movable relative to each other along a direction. Furthermore, via powder outlets in the plasma gun, a stream of powder carried by a carrier gas is directed onto the area of incidence of the plasma jet on the parts to be joined, where the powder is melted by the plasma. In particular, the powder can be a metal powder with additives of a flux agent. Additionally, an inert gas can exit from outlets in the plasma gun surrounding the powder outlets, so that the soldering process can be performed in a cover of shielding gas.

German Patent Application Publication No. DE 10 2007 042 082 A1 discloses a soldering apparatus for soldering solar cells. It exhibits a laser soldering device movable along a surface of a solar cell to be soldered. The apparatus includes a holding down device for holding down a solder band on the solar cell. The solder band preferentially is a copper strip covered with solder. The holding down device is located next to the laser soldering element and forwards in the soldering direction. It is moved together with the laser soldering element at a constant distance above the solar cell. Preferentially, the holding down of the solder band is also done without contact by an air nozzle. To this end hot pressured air can be used, which additionally can pre-heat solar cell and conductor before the laser soldering process. Alternatively, the holding down device can also be a roll at an adjustable height.

European Patent Application No. EP 1 748 495 A1 discloses methods and an apparatus for manufacturing a string of solar cells with plural solar cells, in particular silicon cells, arranged in a row, connected electrically in series as well as mechanically by solder bands. The solder bands are covered with solder on surfaces facing the solar cells. A respective end of each solder band is positioned alternatingly on the top side and on the bottom side of two neighboring solar cells. The solar cell arrangement prepared in this way is passed over one or plural pre-heating zones and is soldered into a solar cell string by means of induction soldering. One inductor can at the same time function as moveable holding down device. The solar cells are moved under the inductor in a stepped and clocked fashion by a conveyor belt, wherein typical clock cycles are about 6 to 7 seconds.

German Patent Application Publication No. DE 10 2008 046 330 A1 discloses a method for electrically contacting contact wires to a side of a solar cell by laser or induction soldering. Preferentially the contact wire is a tinned copper flat wire. Solar cells to be contacted exhibit at least one metallic strip-shaped area (bus bar). Onto this a contact wire is soldered, wherein the soldering duration, or the duration of energy flux into the soldering area, respectively, is 300 ms or more. Furthermore, the soldering area can be cooled with air. This makes possible a reduction of the temperature in the soldering area during the soldering process to between 100° C. and 120° C.

German Patent Application Publication No. DE 10 2009 000 262 A1 discloses a thermal joining method for forming a material bond between at least two surfaces of one or plural work pieces by means of a joining seam. Therein additives are used, which, already prior to the joining, are applied on at least one work piece. The welding energy is supplied via a welding nozzle or head by means of a laser beam, electron beam, plasma beam, or an electric arc. The welding nozzle can be moved relative to the work piece along a direction, wherein the work piece and/or the welding nozzle can be moveable.

German Patent Application Publication No. DE 199 52 043 A1 discloses a method for gas metal arc soldering (GMA soldering) of metallic materials using solder materials and an electric arc with melting or non-melting electrode. The soldering process is conducted in a shielding gas atmosphere. The shielding gas contains one or plural inert gas components. In addition to the inert gases the shielding gas can contain active gas components like oxygen and carbon dioxide.

German Patent Application Publication No. DE 10 2008 011 249 A1 discloses various lithography processes for the plasma coating of pattern structures on surfaces of substrates. First a negative mask of the desired structure is placed onto the surface of the substrate. Then the surface of the substrate and the negative mask are fully coated by means of plasma. After a lift-off process of the coated negative mask, the remaining coating on the substrate remains within the contours of the desired pattern.

International Patent Application No. WO 2011/120714 A2 discloses solar cells as well as methods and devices for their manufacture. Therein at least one conductor is connected mechanically and electrically with the solar cell and/or further conductors by a conductive coating. Conductors can act as collector or bus bar of a solar cell. The conductive coating is deposited from a solution electrolytically or galvanically, or by plasma spraying.

### SUMMARY OF THE INVENTION

The present invention comprises a device for joining a conductor to a substrate, the device having a positioning unit for positioning the conductor with a section to be joined relative to the substrate, at least one first plasma source for generating a plasma, at least one first feed line for feeding a connecting material into the plasma of the at least one first plasma source, and, at least one nozzle of the at least one first plasma source through which a plasma jet with an activated connecting material contained therein is directed onto the section to be joined, so that a disposal joins the conductor with the substrate by a bonded connection.

The present invention further comprises a device for joining a conductor to a substrate, the device having a positioning unit for positioning the conductor with a section to be joined, at least one first plasma source for generating a plasma, wherein the at least one first plasma source is directed onto the section to be joined for providing a first disposal of an activated connecting material to the section to be joined, and, at least one second plasma source arranged downstream to the least one first plasma source, wherein the at least one second plasma source is directed onto the section to be joined, so that a second disposal of a second connecting material is deposited onto the first disposal of the activated connecting material.

The present invention further comprises a device for joining a conductor to a substrate, the device having a positioning unit for positioning the conductor with a first section to be joined, at least one first plasma source for generating a plasma, wherein the first plasma source is directed onto the first section to be joined for providing a first disposal of an activated connecting material to the first section to be joined, and, at least one second plasma source arranged downstream and at a distance to the least one first plasma source, wherein the at least one second plasma source is directed onto a second section to be joined, so that a second disposal of a second connecting material is deposited on the first disposal of the activated connecting material provided by the at least one first plasma source.

The present invention further comprises a method for joining a conductor to a substrate including the steps of positioning the conductor with a section to be joined on a substrate with a positioning unit, generating a plasma in at least one first plasma source and feeding a first connecting material into the plasma, wherein the first connecting material is activated by at least partially changing its state, directing a plasma jet and the activated connecting material contained therein through at least one nozzle of the at least one first plasma source onto the section to be joined, and, depositing the activated connecting material on the section to be joined, so that a first disposal of the activated connecting material joins the conductor with the substrate by a bonded connection.

The present invention further comprises a method for joining a conductor to a substrate, comprising the steps of positioning the conductor with a section to be joined on a substrate by a positioning unit, generating a first plasma in at least one first plasma source and feeding a first connecting material into the first plasma, wherein the first connecting material is activated into a first activated connecting material by at least partially changing its state, directing a first plasma jet and the first activated connecting material contained therein through at least one first nozzle of the at least one first plasma source onto the section to be joined, generating a second plasma in at least one second plasma source and feeding a second connecting material into the second plasma, wherein the second connecting material is activated into a second activated connecting material by at least partially changing its state, directing a second plasma jet and the second activated connecting material contained therein through at least one second nozzle of the at least one second plasma source onto the section to be joined, and, depositing the activated connecting materials from the at least one first and second plasma sources on the section to be joined, so that a disposal of the activated connecting materials joins the conductor with the substrate by a bonded connection.

It is an object of the present invention to provide a fast, cost efficient, flexible, mild, and simple method for forming long-term stable connections of conductors or conductor paths, respectively, on substrates, or their connection with electrical contacts, respectively.

It is a further object of the present invention to provide a flexible device for the fast, cost efficient, simple, and mild forming of long-term stable connections of conductors or conductor paths, respectively, on substrates, or their connection with electrical contacts, respectively.

This object is demonstrated by a device for joining conductors to substrates which comprises a positioning unit for positioning a conductor with a section to be joined relative to the substrate. At least one plasma source is provided for generating a plasma. At least one feed line is used for feeding a connecting material into the plasma of the at least one plasma source. The plasma source has at least one nozzle through which a plasma jet with activated connecting material contained therein is directed onto the section to be joined. As a result a disposal is formed which joins the conductor with the substrate by a bonded connection.

The method according to the present invention is capable of joining diverse conductors and substrates to each other by a material bond. It is suitable for processing substrates of diverse shape and surface properties, consisting of or being composed of electrically conducting, semi-conducting, or insulating materials. In a step of the method a conductor is positioned in a section to be connected on a substrate by a positioning unit. The positioning unit positions the conductor in the section to be connected on or at a short distance above the substrate. Furthermore, a plasma is generated in at least one plasma source and a connecting material is fed into the plasma. The feeding of the connecting material can be done within the plasma source. Therein the nature of the connecting material is changed at least partially. A change of the nature is to be understood as an at least partial change of the physical properties and/or the chemical properties of the connecting material. Such an activation of the connecting material can occur completely or partially, for example only on the surface of the components of the connecting material, by preferentially adjusting the influx of connecting material into the plasma source to the heat flux carried by the plasma. The plasma jet and activated connecting material contained therein is passed in a directed fashion through a respective at least one nozzle from the at least one plasma source to the section to be connected. Thus activated connecting material is deposited on the section to be connected. The activated connecting material forms a disposal which connects conductor and substrate with a material bond.

The positioning unit may additionally be configured for feeding the conductor. The conductor may for example be a metallic wire with or without a coating of oxidation protection or solder, as well as with flux agents enclosed in cavities. The positioning unit may be a wire reel, via which the conductor is continuously supplied.

A relative motion is carried out between the section to be connected and the at least one plasma source along a joining path on the substrate. In various embodiments of the relative motion either the substrate or the plasma source and positioning unit may be at a fixed position.

In an example embodiment, the at least one plasma source and the positioning unit are moved along the joining path at a fixed distance and with the same speed of advance. Likewise a relative motion between plasma source and positioning unit is to be provided, so that additional deposits can also be formed away from the joining path.

The connecting material fed to a plasma source may be composed of plural material components. The material components and their mixing ratio in the disposal may be varied along the joining path. Likewise the layer thickness and the width of the layer may be varied along the joining path.

In an example embodiment, at least one further plasma source may be provided, following the plasma source in a direction of advance along the joining path. By the further plasma source a further disposal, of the same or a different connecting material, may be applied on the disposal. Distance and speed of advance may be chosen such that the disposal has already solidified before depositing the further disposal. The further disposal is deposited at least partially on the disposal.

Furthermore, the conductor can be cooled with a heat sink. Often the thermal expansion coefficient and the heat capacity of the conductor are higher than those of the substrate or of the connecting material. Such differences in the thermal expansion may lead to mechanical stresses and cracks in the disposal of connecting material. The present invention therefore suggests to selectively cool the conductor relative to the substrate or the connecting material at least partially. In this way, the difference in the thermally induced expansion of the conductor in the section to be connected is adjusted to that of the substrate and of the connecting material and at least partially compensated.

A pressure force is exerted on the conductor by the positioning unit, so that the conductor is pressed against the substrate. Additionally, a drag force on the conductor in direction of the direction of advance may be set. The forces exerted by the positioning unit avoid that the heated section of the conductor bends away from the substrate and that bonding errors like for example cavities or delaminations arise in the disposal of connecting material.

Furthermore the plasma jet can cause a physical and/or chemical activation of the substrate and/or the conductor in the section to be connected. For example, dirt or oxide layers can be removed, and the surface properties of conductor and substrate can be changed for better wetability with connecting material. Additionally, at least one further plasma source, preceding the at least one plasma source in the direction of advance, can perform a plasma treatment of conductor and/or substrate.

Furthermore, the connecting material may include material components of at least one type of powder or may be completely in the form of powder. Such a connecting material may, according to the present invention, be mixed with a carrier gas or a carrier liquid. The mixture of carrier gas or carrier liquid and the connecting material may furthermore be subject to a homogenization prior to feeding it into the plasma source. This may for example be achieved by an ultrasonic source, a piezoelectric actuator, or a powder nozzle. Preferentially the carrier gas and/or a plasma gas fed into the plasma source are inert gases, like for example argon or nitrogen. The inert gas atmosphere prevents oxidation of the activated surfaces of connecting material, conductor, and substrate in the plasma jet. Furthermore small mass fractions of reducing gases like hydrogen or carbon oxides may be added.

The present invention furthermore relates to a device for joining conductors to substrates. The device includes a positioning unit for positioning a conductor at least in a part of a section to be connected of the substrate. Furthermore the device includes at least one plasma source for generating a plasma. Through at least one feed line a connecting material can be fed to the plasma of the plasma source. The component of the connecting material which is in the form of powder is supplied as powder in packages. As already described, the powder is mixed with the carrier gas or the carrier liquid, so that the connecting material is obtained which can be fed to the plasma source with the required fluidity. At the plasma source at least one nozzle is formed, through which a plasma jet with activated connecting material contained therein is directed onto the section to be connected. For depositing plural disposals of structured shape it is particularly advantageous to provide the opening of the nozzle with a shutter. A forming disposal connects the conductor and the substrate with a material bond.

Additionally, the device according to the present invention may include at least one relocation system. The relocation system is configured to generate a three-dimensional relative motion of the substrate relative to the at least one plasma source and the positioning unit along a joining path.

The relocation system may include various relocation devices. A first relocation device corresponds to the substrate holder. A respective second relocation device is connected with at least one of the plasma sources. A third relocation device is connected with the positioning unit. The relocation devices are configured for performing arbitrary translations and tilting motions with respect to the X-coordinate direction, Y-coordinate direction and/or Z-coordinate direction.

In an embodiment of the device according to the present invention, each of the at least one plasma source has a feed line for feeding connecting material into the plasma. Each feed line may furthermore include a feed control unit. A feed control unit according to the present invention is configured for the adjustable feed control of a carrier gas and a respective at least one material component of the connecting material. Depending on the field where the device according to the present invention is used, the feed control units may be configured for feeding and controlling the feeding of, for example, wires, solid bodies in powder or granular form, liquids or gases. In particular, it allows to completely shut down the feed of a material component, and to set desired mixing ratios of two material components.

Furthermore the device may include at least one heat sink, assigned to the conductor at the section to be connected or at the positioning unit. Preferably, in this embodiment of the device according to the present invention, conductors with high heat conductivity are used. In this way, the heat sink can thermally contact the conductor preferentially outside of the plasma jet. The heat flux carried by the conductor into the heat sink causes an effective cooling in the section to be connected.

A least one further plasma source may precede and/or follow the at least one plasma source in the direction of advance. A preceding plasma source, for example, serves for a plasma pre-treatment of sections of the conductors and/or substrates to be connected in as complete as possible an area. Likewise, along the joining path an additional disposal may be applied on the substrate, onto which subsequently the conductor is positioned and connected according to the present invention. A following plasma source, for example, serves for depositing from a different angle than the depositing from the at least one plasma source.

Furthermore, plural devices according to the present invention may be integrated in a system which is configured for the parallel processing of one or plural substrates. In particular, such a system is capable of joining conductors to two or more respective substrates with a material bond in one process step. By depositing a disposal of for example conductive connecting material, the substrates or contact locations may in this way be electrically connected to each other.

The width of the disposal orthogonal to the direction of advance can be set by the distance of the nozzle to the substrate in addition to the configuration of the nozzle. The setting of the layer thickness of the disposal is, according to the present invention, influenced also by the mass fluxes of the components of the connecting material and of the plasma gas, as well as by the speed of advance. Typical widths of the disposal for example are between 1 mm and 5.5 mm. However, the method can also be employed for full area coating. Smaller widths of the disposal are also achievable by the method according to the present invention, in particular in combination with lithography methods.

A particular advantage of the present invention is that the amount of heat carried to substrate and conductor by the mixture of plasma and activated connecting material can be reduced with respect to known soldering methods. This influx of heat can be set by modulating the plasma properties, the distance between nozzle and substrate, increase of the speed of advance and/or additional cooling. If the speed of advance for example is chosen such that the duration of the plasma-powder-coating process in a section to be connected of about 1.0×3.5−5.5 mm² is below 20 ms, then the temperature there typically is in the range of about 70 to 150° C. On the one hand, thermally sensitive substrates like solar cells, paper, food, polymer films or synthetic materials (like thermoplastic materials, PA, PMMA, PPS, PBA, nylon, ABS, etc.) can be processed in this way.

On the other hand, substrates, conductors, connecting materials or compound materials with different thermal expansion coefficients can be processed, because the lower influx of heat in comparison with methods like for example contact soldering reduces the difference of the thermal expansion of substrates, conductors, and disposal of connecting material. Thus, mechanical stress or formation of cracks in the disposal can be avoided. Furthermore, according to the present invention, the influx of heat occurs only locally about a limited area about the section to be connected. This makes possible performing the method according to the present invention in parallel at plural neighboring sections of a substrate, without exceeding a given threshold value of its total increase in temperature.

The material components may be electrically conductive (e.g. metal powder, graphite, fullerenes, like e.g. carbon nanotubes, or other conductive inorganic compounds, like e.g. salts or organic compounds like DNA or saccharides or dyes for use in food), or electrically insulating (e.g. glasses like quartz, intrinsic/undoped silicon, silicon nitride, ceramics, or polymers, etc.), or semi-conducting (e.g. doped silicon or gallium arsenide etc.).

Furthermore, the material components may be composed of alloys or mixtures. Metallic material components according to the present invention include soft solder (e.g. tin, silver, tin-silver, or their alloys) and hard solder (e.g. zinc, aluminum, nickel, copper, or their alloys), which often are more cost efficient than the soft solders mentioned and have good wetting properties.

Furthermore, material components may be flux agents for increasing the fluidity of metallic components or reduction agents for chemically activating the surfaces to be connected of substrates, conductors, and/or connecting materials.

Furthermore, the above-mentioned material components may be dispersed in filler materials, or may be dissolved in liquid solvents. The material components of the connecting material partially can escape in the form of gas, and thus only partially become a component of the disposal. In particular, according to the present invention, the thermal expansion coefficient of the disposal of connecting material may be adjusted to the thermal expansion coefficient of substrates or conductors by a suitable choice of the mixing ratio.

The finer grained the material components in powder form of the connecting material are, the larger their total surface in relation to their volume is, and the colder the plasma jet can be, which partially or fully melts the connecting material. Compared with known spraying methods, in this way disposals of a low porosity can be formed, wherein a low influx of heat into the substrate results. The maximum tensile strength and conductivity of electric current and/or heat can be influenced by the cross section of the disposal and the choice of connecting material. Depending on the materials used sufficient adhesion of the disposal to the substrate is already achieved with layer thicknesses of about 10 to 500 μm.

Additionally, the nozzle can be configured as a diffuser for improved mixing and homogenization, as well as for setting the extent of diffusion of the aerosol of plasma and activated connecting material.

An example of application of the present invention is the manufacturing of solar cell modules. By way of example, in what follows the manufacturing of solar cell modules, and therein the technological problems which can be overcome by the present invention, are described.

Plural solar cells are connected to solar cell modules by one or more conducting wires. A simple row of connected solar cell modules often is called solar cell string. Due to costs, the components of solar cells are designed ever more material efficient. For example, the semiconducting wafers of a solar cell typically are only 180 μm thin. A corresponding statement is true of the conducting wires. Therefore, the mechanical stability of a solar cell and the maximum electric current that can be passed through a solar cell tend to decrease. In order to limit the current, it is advisable to electrically connect the solar cells in series. The conducting wires of the photo electrically active side (side facing the sun) of a solar cell are connected to the shadow side of a neighboring solar cell. The shadow side typically is partially or fully metalized, e.g., with a screen printing paste of high aluminum content. The side facing the sun carries a plurality of conductor fingers, which act as collectors for charge carriers separated by the photoelectric effect. As these conductor fingers block light, their total area is minimized as far as possible, in order to increase the efficiency of the solar cell.

Known joining methods include for example induction or laser soldering, or electroplating methods. With respect to soldering, both the shadow side and the side facing the sun typically are restricted with respect to the choice of solder material. In particular, the choice of materials for connecting materials is for example restricted to the typical Al-screen-printing- or Al-OVD-layers used with solar cells. Therefore, in a process step preceding the soldering of contact wires onto the side facing the sun or onto the shadow side, respectively, usually additional “bus bars” of materials which can be soldered well and which are electrically conductive (like e.g. Ag, Sn, or their alloys) are metalized onto the solar cell. The bus bars act as electrically conductive adhesion layer between the conductor and the surface materials of the solar cell. While tin-based soft solders in general meet this requirement, their solder layers show insufficient adhesive tensile strength on certain substrates.

For electrically connecting the solar cells with a solar module typically so-called stringer soldering machines are used. In soldering with stringer soldering machines the solar cells for example are pre-heated, and the contact wire is soldered onto the bus bars on the solar cell by means of soldering heads. As an alternative, a conducting wire can be contactlessly soldered onto metalized bus bars by means of a laser soldering apparatus. Therein often the contact wire is not connected across its entire contact area with the solar cell, but only by a suitable number of solder spots.

With laser soldering the energy influx to the substrate can be reduced in comparison with contact soldering methods. Additionally, an overheating of the solar cell may be countered for example by air cooling. If the thermal stress of the solar cell is too high, bonding errors like micro cracks in the solder bond or mechanical stresses of the solar cell may result. Applying bus bars and conducting wires onto the solar cell in two separate process steps requires much technical effort and much effort in terms of the apparatus, and increases the costs of the process. In particular, such a separate configuration of the process requires an additional and potentially error prone repositioning step of conducting wire and bus bar.

In order to form a solder bond of good adhesive properties, and for reducing the internal stresses of the neighboring bonding materials arising from different expansion coefficients, the solar cell is pre-heated to a specific temperature in the soldering process. Then the contact wire is soldered to the metalized bus bar. A pre-heating can damage the solar cell or the solder bond, respectively, depending on the temperature and duration of the thermal stress.

For optimizing the solder bond, flat wires of copper having a large contact area in relation to volume, are soldered on bus bars on the solar cell in an example embodiment. The aspect ratio of thickness to width of the flat wire typically is 1:10 to 1:20. The contact wire of copper is tin-coated, in order to improve the solderability. This causes additional process or material costs, respectively.

These and other objects, advantages and features of the present invention will be better appreciated by those having ordinary skill in the art in view of the following detailed description of the present invention in view of the drawings.

### BRIEF DESCRIPTION OF THE DRAWINGS

In what follows, embodiments according to the present invention of the device and of the method for joining conductors to substrates are described in detail with reference to the accompanying drawings. These embodiments with examples of detail are not to be considered as limitations of the scope of the present invention. The present invention expressly also covers the combinations of features of the embodiments described below.

In the accompanying drawings:

FIG. 1 is a schematic sectional view of a device, according to an example embodiment of the present invention;

FIG. 2 is a schematic sectional view of a device with a relocation system, according to an example embodiment of the present invention;

FIG. 3 is a schematic sectional view of a device with feed control units, according to an example embodiment of the present invention;

FIG. 4 is a schematic side view of the allocation of a plasma source to the conductor to be joined and the substrate, according to an example embodiment of the present invention;

FIG. 5 is a schematic side view of a further possibility of the allocation of a plasma source to the conductor to be connected and to the substrate, according to an example embodiment of the present invention;

FIG. 6 is a schematic side view of the allocation of two plasma sources to the conductor to be joined and the substrate, according to an example embodiment of the present invention;

FIG. 7 is a schematic side view of the allocation of two plasma sources to the conductor to be joined and the substrate, according to an example embodiment of the present invention;

FIG. 8 is a schematic view of the allocation of two plasma sources to the conductor to be joined and the substrate, wherein the direction of advance points out of the drawing plane, according to an example embodiment of the present invention;

FIGS. 9A to 9F are cross-sectional views showing shapes of conductors, which are connected to the substrate by means of the disposal by a bonded connection, according to example embodiments of the present invention;

FIGS. 10A to 10D are cross-sectional views of various types of the disposal and the connection of the conductor to the substrate, according to example embodiments of the present invention;

FIGS. 11A and 11B are cross-sectional views of various topologies of the substrate and of the resulting connection of the conductor to the substrate, according to example embodiments of the present invention;

FIG. 12 is a schematic top view of a connection between the substrate and the conductor with additional disposals, according to an example embodiment of the present invention;

FIG. 13 is a schematic top view of connections by a bonded connection between substrate and conductor, according to an example embodiment of the present invention;

FIG. 14 is a schematic view of an example embodiment of a device with an example embodiment of the positioning unit for the conductor;

FIG. 15 is a detailed view of the positioning unit shown in FIG. 14; and,

FIGS. 16A-16E are schematic views of the manufacturing process of a solar cell module, according to example embodiments of the present invention.

### DETAILED DESCRIPTION OF THE PRESENT INVENTION

At the outset, it should be appreciated that identical reference characters in the drawings are used for like elements of the present invention or elements of like function. For the sake of clarity, only those elements and reference characters which are of relevance to the shown aspects of the respective example embodiment of the present invention are shown repeatedly.

While the present invention is described with respect to what is presently considered to be the preferred aspects, it is to be understood that invention is not limited to the particular methodology, materials and modifications described and as such may, of course, vary. Furthermore, it is to be understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

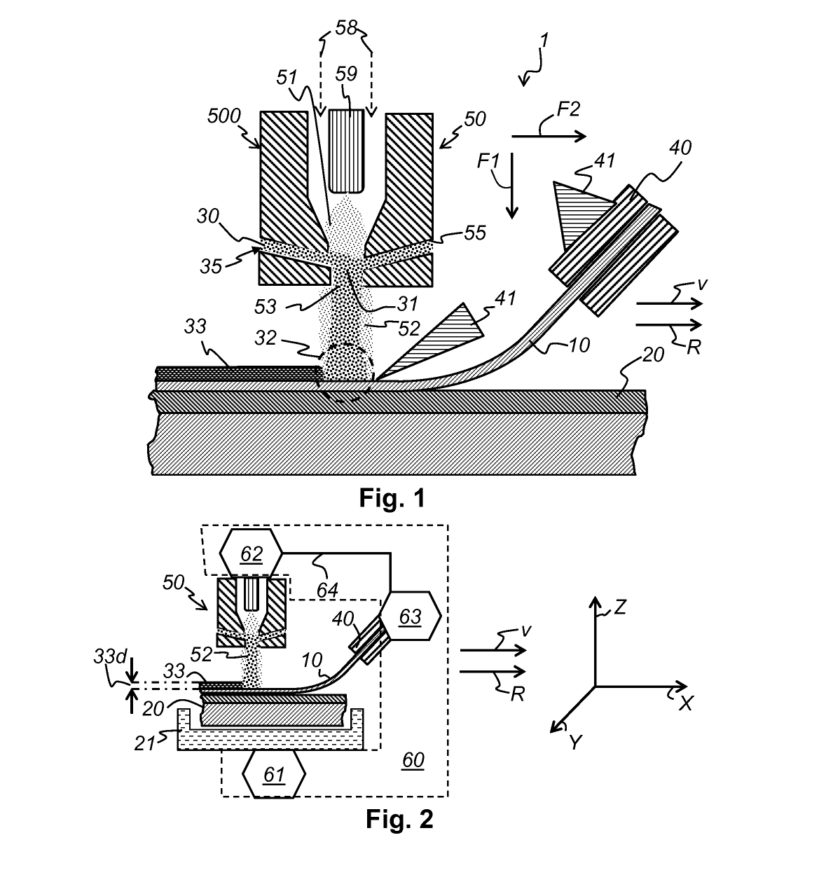

FIG. 1 is a schematic sectional view of device 1, according to an example embodiment of the present invention. The section is parallel to direction of advance R and to speed of advance v. In plasma source 50, plasma gas 58 is introduced and ignited into plasma 51. For example, the conversion into plasma of process gas 58 can be caused by electrical energy from a voltage source (not shown). In an example embodiment, a pulsed or continuous DC or AC voltage may be applied to electrode 59 relative to housing 500 of plasma source 50. Besides settable parameters like the applied voltage, the mass flux and the composition of plasma gas 58, the properties of plasma 51 are also determined by the geometry of plasma source 50. Via at least one feed line 55, connecting material 30 is fed to plasma 51.

In the embodiment shown in FIG. 1, connecting material 30 is at least partially in the form of powder. By plasma 51, the physical properties and/or the chemical properties of connecting material 30 are changed. Thus, at least a partial change of the nature of the powder particles of connecting material 30 occurs. One possibility is that the state of matter, the rheological and/or chemical properties of the powder particles of connecting material 30, are activated. Carrier gas 35, into which connecting material 30 in powder form is mixed or dispersed, increases its fluidity. In order to avoid a clumping of powder particles, a homogenization of the mixture of connecting material 30 with carrier gas 35 may additionally be provided.

Furthermore, feed lines 55 for feeding connecting material 30 may exhibit heating elements (not shown) for pre-heating connecting material 30. In this way, the mean enthalpy of plasma 51 for achieving the desired change of state of matter of connecting material 30 can be reduced. Plasma jet 52 and activated connecting material 31 contained therein is passed out of plasma source 50 through nozzle 53 and is directed onto section 32. In section 32, substrate 20 and conductor 10 (which is to be connected to substrate 20) are arranged. Disposal 33 is deposited in section 32 out of activated connecting material 31 contained in plasma jet 52. Disposal 33 joins conductor 10 to substrate 20 by a material bond. Conductor 10 is positioned in section 32 by positioning unit 40. Positioning unit 40 can, for example, be tube-shaped. Tube-shaped positioning unit 40 is not in contact with substrate 20. Out of tube-shaped positioning unit 40, wire-shaped conductor 10 is supplied, and its internal stress is used for pressing it against substrate 20 with a settable pressure force Fl. Additionally, positioning unit 40 may tighten wire-shaped conductor 50 with drag force F2. If conductor 10 experiences a higher thermal expansion in section 32 to be heated when heated by plasma jet 52, such a drag tension can avoid a bending away of the heated section of conductor 10 from substrate 20, and therefore avoid bonding errors in disposal 33.

After cooling disposal 33, however, conductor 10 may contract correspondingly to a greater extent than substrate 20. This may lead to mechanical stresses and deformations of substrate 20, and to bonding errors like micro cracks in disposal 33. This can be remedied, on the one hand, by a reduction of the influx of heat from plasma 51. On the other hand, conductor 10 may be cooled, in particular selectively, by at least one heat sink 41, in order to at least partially compensate its heat expansion different from that of substrate 20. Heat sink 41 may, for example, be coupled directly to section 32, or may be coupled via positioning unit 40 to conductor 10 in a thermally conductive manner. Heat sink 41, for example, may be a stream of cooling gas directed on a section of conductor 10 between plasma jet 52 and positioning unit 40. Alternatively, heat sink 41 may be a thermally conductive sliding contact, thermally coupled to heat sink 41. In particular, heat sink 41 may be integrated into positioning unit 40. Such a heat sink 41, for example, may be a block of copper through which cooling water is passed, or a controllable Peltier element.

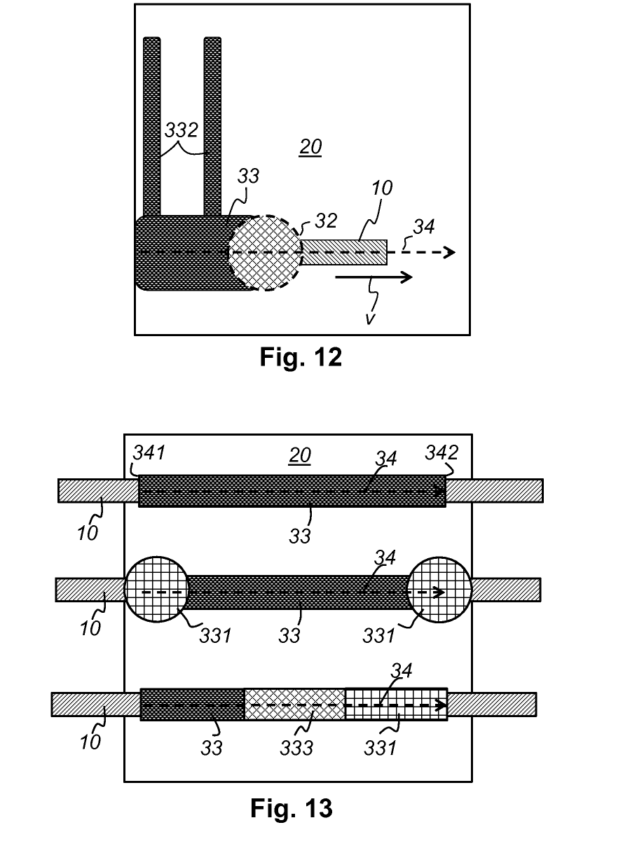

FIG. 2 is a schematic sectional view of device 1 with relocation system 60, according to an example embodiment of the present invention. Relocation system 60 is configured for generating a three-dimensional relative motion of substrate 20 relative to at least one plasma source 50 and positioning unit 40 along joining path 34 (shown in FIG. 12). Along joining path 34, section 32 to be joined is guided and disposal 33 is deposited. Its path can be along an arbitrary trajectory on one or plural substrates 20. Correspondingly, the orientation of direction of advance R and speed of advance v can vary along joining path 34 (see FIG. 12). Disposal 33 may be deposited on joining path 34 continuously or piece-wise. By setting the speed of advance v, relocation system 60 can for example influence the joining time per area of section 32, thickness 33d of disposal 33, and the influx of heat onto substrate 20 and conductor 10 from plasma jet 52.

By suitable adaptation of the geometry of nozzle 53 the form (in particular the widening) and direction of plasma jet 52 exiting from plasma source 50 can be set.

In an example embodiment, relocation system 60 may include various relocation devices 61, 62, and 63. With first relocation device 61, which is assigned to substrate holder 21, at least a one-dimensional motion in X-coordinate direction X, or in Y-coordinate direction Y, or in Z-coordinate direction Z may be performable. With second relocation device 62, which is connected to plasma source 20, a three-dimensional motion in direction X, direction Y, and direction Z can be performed. With third relocation device 63, which is connected to positioning unit 40, at least a three-dimensional motion in direction X, direction Y, and direction Z can be performed. Relocation devices 61, 62, and 63 are configured for performing arbitrary translations and tilting motions relative to direction X, direction Y, and direction Z.

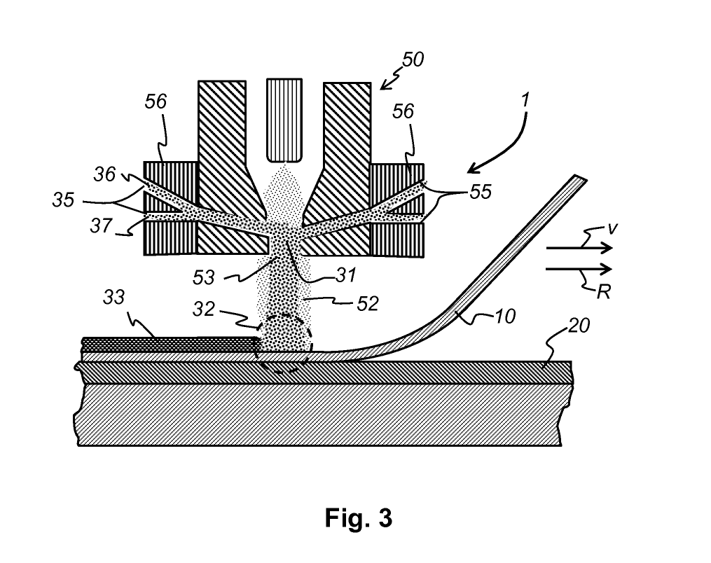

FIG. 3 is a schematic sectional view of a device 1 with feed control units 56, according to an example embodiment of the present invention. Preferably, each feed line 55 may include feed control unit 56. Feed control unit 56 according to the present invention is configured for adjustably controlling the feed of carrier gas 35 and of a respective at least one material component 36 and 37 of connecting material 30. The feed of material component 36 and 37 can be shut off completely with feed control unit 56. Also, the arbitrary mixing ratios of the two material components 36 and 37, as well as the arbitrary mixture gradients along joining path 34 (see FIG. 12) can be set with feed control unit 56.

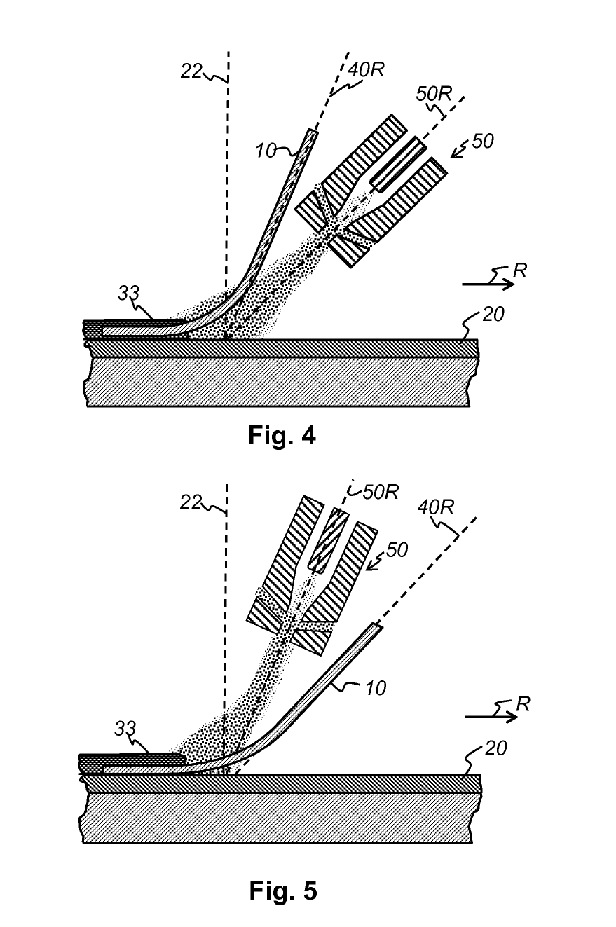

FIG. 4 is a schematic side view of the allocation of plasma source 50 to conductor 10 and substrate 20, according to an example embodiment of the present invention Therein, plasma source 50 and positioning unit 40 are directed to section 32 to be joined along respective axis 50R and 40R, tilted relative to normal 22 of substrate 20. The tilting therein is done in direction of advance R. In FIG. 4, tilted axis 50R of plasma source 50 is inclined more than tilted axis 40R of positioning unit 40. Due to this configuration, disposal 33 between substrate 20 and conductor 10 is created. Substrate 20 and conductor 10 in this case do not have direct material contact.

FIG. 5 is a schematic side view of a further possibility of the allocation of plasma source 50 to conductor 10 to be connected and to substrate 20, according to an example embodiment of the present invention. The difference with respect to the embodiment in FIG. 4 is that tilted axis 40R of positioning unit 40 is inclined more than tilted axis 50R of plasma source 50. With the embodiment described here, thickness 33d of embodiment 33 at the upper side of conductor 10 is bigger than in the embodiment in FIG. 4. The “upper side” therein is defined with respect to normal 22 of substrate 20.

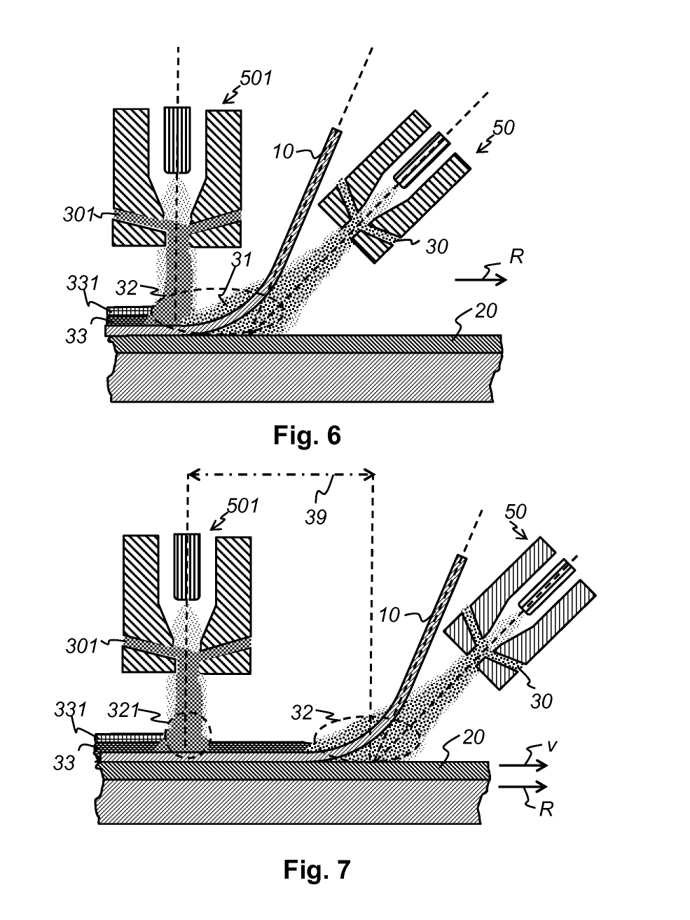

FIG. 6 is a schematic side view of the allocation of two plasma sources 50 and 501 to conductor 10 to be joined and to substrate 20, according to an example embodiment of the present invention. Second plasma source 501 is directed onto section 32 to be joined. Plasma source 501 is downstream to plasma source 50 in direction of advance R. In this way, second disposal 331 of second connecting material 301 is deposited onto disposal 33 of not yet solidified, activated connecting material 31. As both connecting material 30 and connecting material 301 are in contact in the activated state, the diffusion of connecting materials 30 and 301 into each other, and thus the adhesion between disposals 33 and 331, is enhanced. However, the total influx of heat per area and time increases, as both plasma sources 50 and 501 are directed onto the same section 32 simultaneously or with a small time gap. The selection of connecting materials 30 and 301 can be made by the user depending on the requirements. Connecting materials 30 and 301 may, for example, differ in all material components 36 and 37 (see FIG. 3), they may match in part, or also match in all material components 36 and 37 (see FIG. 3).

FIG. 7 is a schematic side view of the allocation of two plasma sources 50 and 501 to conductor 10 to be joined and to substrate 20, according to an example embodiment of the present invention. In contrast to the embodiment shown in FIG. 6, second plasma source 501 is directed onto second section 321 to be connected, which is at distance 39 from section 32 to be joined. The influx of heat from plasma source 50 in this way can be removed at least partially, wherein distance 39 and speed of advance v influence the cooling time and thus the temperature reached at second section 321 to be joined. Thus, the local thermal stress of substrate 20 per area and time diminishes. Distance 39 and speed of advance v can be set in such a way with relocation system 60 that connecting material 30 of disposal 33 has already solidified at the time of depositing second disposal 331. This is, for example, advantageous in forming second disposal 331 of an electrically insulating connecting material 301 on disposal 33 of conductive connecting material 30.

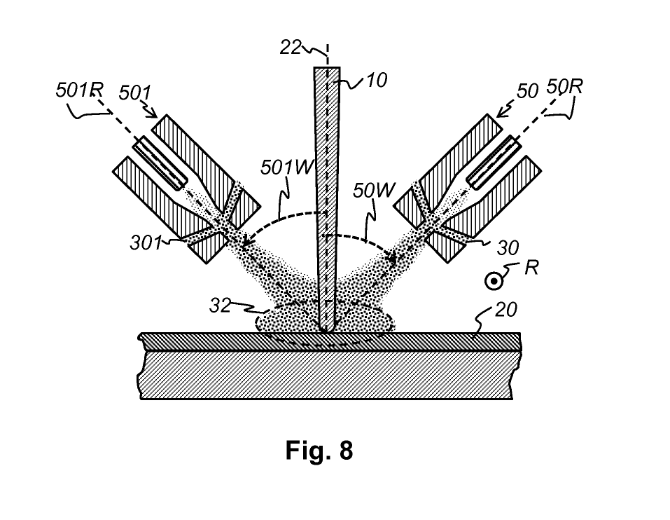

FIG. 8 is a schematic view of the allocation of two plasma sources 50 and 501 to conductor 10 to be joined and substrate 20, wherein direction of advance R points out of the drawing plane. Conductor 10 is positioned in section 32 to be joined to substrate 20 by positioning unit 40 (not shown here). Plasma sources 50 and 501 are arranged in such a way with respect to conductor 10 to be joined and to substrate 29 that tilt axes 50R and 501R of plasma sources 50 and 501 are tilted with respect to normal 22 of substrate 20 at the location of section 32 by respective angles 50W and 501W. With such a tilting, shadowing effects for plasma sources 50 and 501 on substrate 20, which are possibly caused by conductor 10, are reduced or avoided. Alternatively, conductor 10 may be positioned at a small distance (not shown) above substrate 20 in section 32 to be joined by positioning unit 40. In this way, conductor 10 and substrate 20 can be joined by a disposal (not shown) without direct contact between each other.

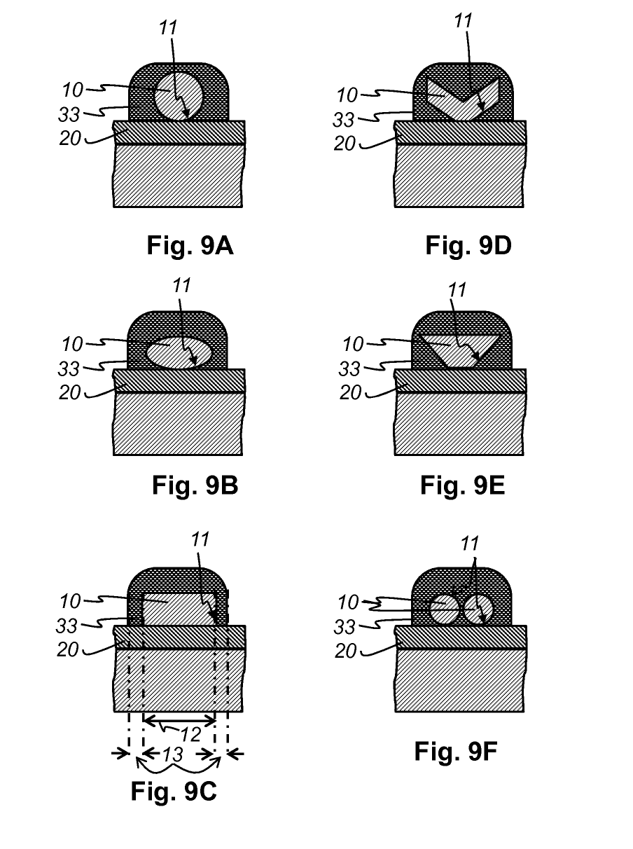

FIGS. 9A to 9F are cross-sectional views showing shapes 11 of conductors 10, which are connected to substrate 20 by means of disposal 33 by a bonded connection, according to example embodiments of the present invention. Cross-sectional shape 11 of conductor 10 may for example be round (see FIG. 9A), elliptical (see FIG. 9B), rectangular (see FIG. 9C), v-shaped (see FIG. 9D), or trapezoidal (see FIG. 9E). Furthermore, conductor 10 may be composed of a plurality of conducting wires or of a wire mesh. FIG. 9F shows, by way of example, conductor 10 composed of two conducting wires of round cross-sectional shape 11 each. Conductor 10 may also be disposal 33. The smaller the area of contact 12 of conductor 10 on substrate 20 is relative to its cross-sectional shape 11, the larger the area of adhesion 13 between connecting material 10 and to substrate 20, and the more stable the adhesion between disposal 33 and substrate 20.

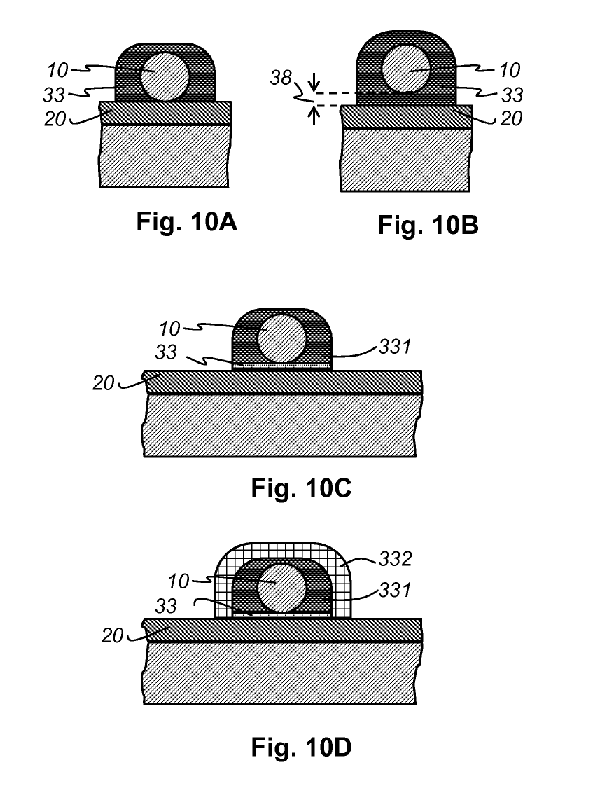

FIGS. 10A to 10D are cross-sectional views of various types of disposal 33 and the connection of conductor 10 to substrate 20, according to example embodiments of the present invention. FIG. 10A shows conductor 10 arranged directly on substrate 20 and embedded in disposal 33. FIG. 10B shows conductor 10 completely surrounded or enclosed by disposal 33. FIG. 10C shows conductor 10 lying on top of disposal 33. Disposal 33 and conductor 10 are covered by second disposal 331. The disposal herein can act as adhesion layer (e.g. a bus bar of a solar cell) or as electrically insulating layer. In FIG. 10D, the structure shown in FIG. 10C is covered by additional disposal 332, which can be configured as protective layer against mechanical or chemical damage, as anti-reactive layer, or as heat dissipation layer.

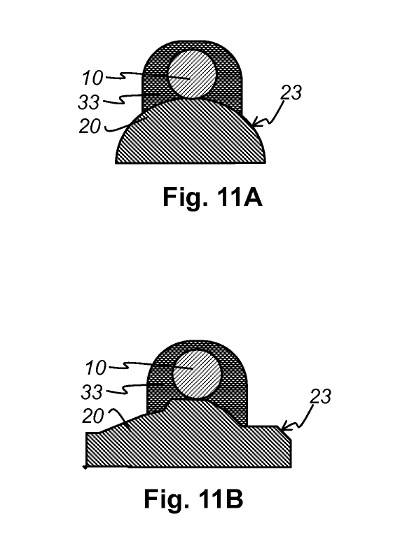

FIGS. 11A and 11B are cross-sectional views of various topologies 23 of substrates 20 and of the resulting connection of conductor 10 to substrate 20, according to example embodiments of the present invention. FIG. 11A and FIG. 11B show substrate 20 with a round or arbitrarily shaped topology 23, respectively.

FIG. 12 is a schematic top view of a connection between substrate 20 and conductor 10 with additional disposals 33, according to an example embodiment of the present invention. Disposal 33 is formed between substrate 20 and conductor 10 along joining path 34. Preferably, by a relative motion between plasma source 50 with respect to positioning unit 40, additional disposals 332 are deposited away from joining path 34 and are connected to disposal 33 or substrate 20, respectively, by a bonded connection.

FIG. 13 a schematic top view of connections by a bonded connection between substrate 20 and conductor 10, according to an example embodiment of the present invention . Firstly, disposal 33 along joining path 34 may be composed of a single connecting material 30. Secondly, further disposal 331 may mechanically strengthen the connection between conductor 10 and substrate 20 at ends 341 and 342 of disposal 33. For example, substrate 20 may be a solar cell, conductor 10 a contact wire, and disposal 33 a bus bar and a conductive solder layer at once. If substrate 20 for example is solar cell 200, it is particularly advantageous to form further solder layer 331 out of an insulator like fused silica (SiO₂), in order to avoid an electrical short circuit of side 203 facing the sun with shadow side 202, of opposite polarity, of solar cell 200. Thirdly, along joining path 34 disposal 33 of connecting material 30 may be deposited, which transitions into further disposal 331 of further connecting material 301 via transition zone 333 in a materially connected way and with a continuous mixture gradient. By a system according to the present invention and by performing the methods according to the present invention, for example all the connections shown in FIG. 13 can be formed on a substrate 20 in parallel.

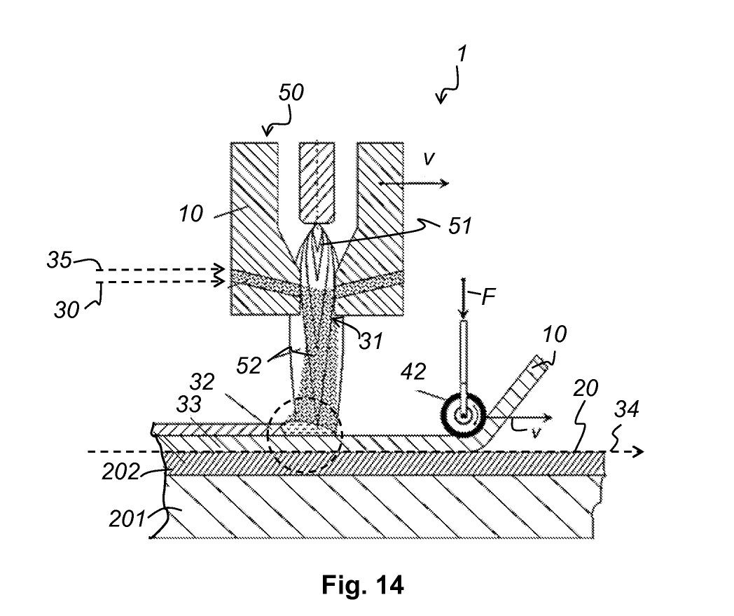

FIG. 14 is a schematic view of an example embodiment of device 1 with an example embodiment of positioning unit 40 for the conductor 10. Positioning unit 40 is configured as sheave 42. Sheave 42 guides conductor 10 along joining path 34. In order to avoid mechanical damage, it may be configured to be contactless with respect to substrate 20.

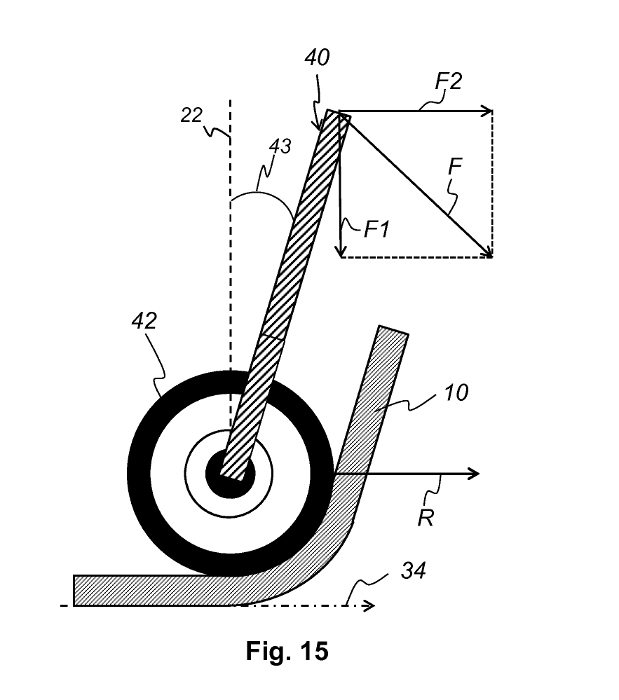

FIG. 15 shows a detail view of sheave 42, which is tilted in direction of advance R by angle 43 relative to normal 22 of substrate 20. Sheave 42 guides a wire-shaped conductor 10 and is capable of exerting force F on conductor 10. Force F is composed of pressure force Fl along normal 22 of substrate 20 and/or drag force F2 along joining path 34.

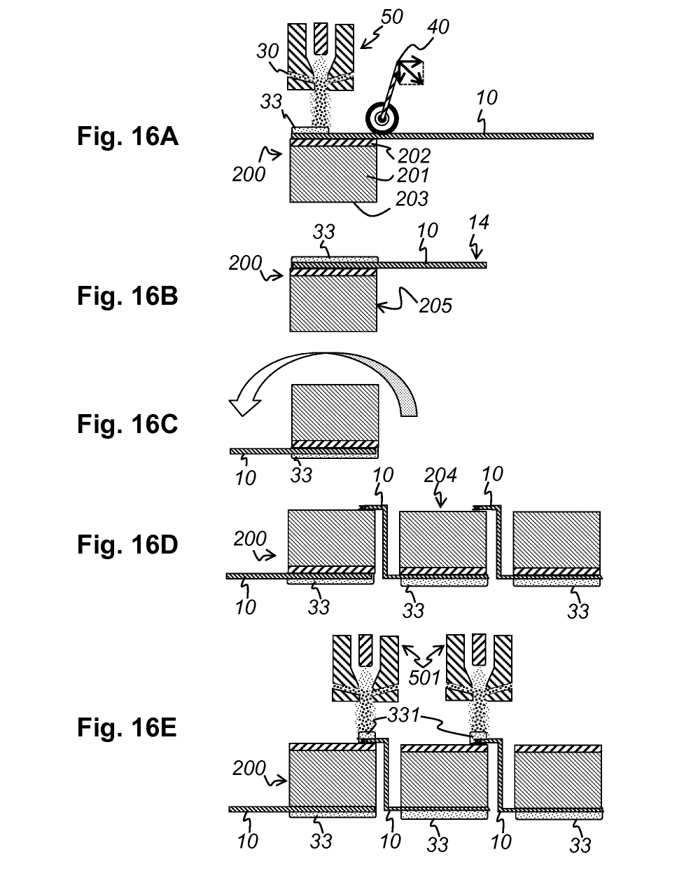

FIGS. 16A-16E are schematic representations of the manufacturing process of a solar cell module, using the method according to the present invention or device 1 according to the present invention, respectively. Substrate 20 herein is solar cell 200. Solar cell 200 typically includes a wafer with a p-n junction 201. The photoelectrically active p-n junction is facing towards side 203 facing the sun of solar cell 200. Its shadow side 202 usually carries a full or partial metallization of, e.g. aluminum (Al) or screen-printing pastes of high Al content, which are difficult to solder. In a first process step the bus bar and conductor 10 are applied on shadow side 202 of solar cell 200. In case the wire-shaped conductor has not been pre-cut yet, conductor 10 is cut, wherein excess end 14 remains on at least one side 205 of solar cell 200. In further steps, plural solar cells 200 are rotated and arranged in such a way that excess end 14 of conductor 10 of solar cell 200 lies on side 203 facing the sun of neighboring solar cell 204. Eventually, excess end 14 of conductor 10 of solar cell 200 is soldered to side 203 facing the sun of neighboring solar cell 204. In this way, a string of solar cells electrically connected in series, or a solar cell module, respectively, result.

A system according to the present invention and the methods according to the present invention in particular are suitable for the parallel or consecutive execution of the steps of applying bus bar and conductor 10 on solar cell 200 and of soldering conductor 10 to neighboring solar cell 204.

Preferably, disposal 33, joining conductor 10 to substrate 20 by a bonded connection, acts both as an ordinary bus bar and as an ordinary solder layer. In addition, plasma jet 52 and active materials contained in plasma jet 52 can pre-heat solar cell 200 and/or physically and/or chemically activate it in section 32. Correspondingly, disposal 33 is formed in one step. Furthermore, using the present invention obviates a repositioning step of conductor 10 on the bus bar.

By adjusting the process parameters (e.g., speed of advance v, the configuration of nozzle 53, the distance between nozzle 53 and substrate 20, the mass fluxes of plasma gas 54, carrier gas 35, and, e.g., connecting materials 30 in powder form, etc.) the geometry, characteristics, and properties of the plasma coatings can be optimized. For example, by a suitable setting of the speed of advance v and corresponding adjustment of the further process parameters, the duration of thermal stress on section 32 to be coated of 1.0×3.5−5.5 mm² can be reduced to about 20 ms, and along the entire joining path 34 of a typical solar cell 200 to below 1.0 s. With clock cycles below 1.0 s the method according to the present invention is about one order of magnitude faster than, for example, the method disclosed on the European patent application EP 1 748 495 A1. Furthermore, according to the present invention, a pre-heating or pre-treatment of solar cell 200 is not necessary. In order to reduce the thermal stress, according to the present invention and depending on the combination of materials, the temperature of the substrate can be reduced to below 100° C. In addition, the thermal stress occurs locally.

Due to the low mechanical, electrostatic, and thermal stress caused by the method according to the present invention, solar cells 200 can be manufactured from ever thinner and thus more fragile wafer material. It is also possible to manufacture solar cells 200 from semi-conducting films with a p-n junction on e.g. an organic basis.

Thus, it is seen that the objects of the present invention are efficiently obtained, although modifications and changes to the invention should be readily apparent to those having ordinary skill in the art, such modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention as claimed.

### LIST OF REFERENCE CHARACTERS

1 Device
10 Conductor
11 Cross sectional shape
12 Area of contact
13 Area of adhesion
14 Excess end
20 Substrate
21 Substrate holder
22 Normal
23 Topology
200 Solar cell
201 Wafer with p-n junction
202 Shadow side
203 Side facing the sun
204 Neighboring solar cell
205 Side
30 Connecting material
31 Activated connecting material
32 Section to be connected
33 Disposal
33d Thickness
34 Joining path
35 Carrier gas
36 First material component
37 Second material component
38 Intermediate layer
39 Distance
301 Further connecting material
321 Further section to be connected
331 Further disposal
332 Additional disposal
333 Transition area
341 End
342 End
40 Positioning unit
40R Tilted axis
41 Heat sink
42 Sheave
50 Plasma source
50R Tilted axis
50W Angle
501W Angle
51 Plasma
52 Plasma jet
53 Nozzle
54 Plasma gas
55 Feed line
56 Feed control unit
57 Nozzle attachment
58 Plasma gas
59 Electrode
500 Housing
501 Further plasma source
501R Tilted axis
571 First nozzle opening
571 Second nozzle opening
60 Relocation system
61 First relocation device
62 Second relocation device
63 Third relocation device
64 Connection
71 Applying bus bar and conductor
72 Cutting the conductor
73 Rotating
74 Arranging
75 Soldering
F Force
F1 Pressure force
F2 Drag force
R Direction of advance
v Speed of advance
X X-coordinate direction
Y Y-coordinate direction
Z Z-coordinate direction

What is claimed is:

1. A device for joining a conductor to a substrate, comprising:
a positioning unit for positioning the conductor with a section to be joined relative to the substrate;
at least one first plasma source for generating a plasma;
at least one first feed line for feeding a connecting material into the plasma of the at least one first plasma source; and,
at least one nozzle of the at least one first plasma source through which a plasma jet with an activated connecting material contained therein is directed onto the section to be joined, so that a disposal joins the conductor with the substrate by a bonded connection.

2. The device of claim 1, wherein at least one relocation system is provided, which is configured to generate a three-dimensional relative movement of the substrate with respect to the at least one first plasma source and the positioning unit along a joining path.

3. The device of claim 1, wherein the at least one first plasma source exhibits at least one second feed line for feeding the connecting material into the plasma.

4. The device of claim 3, wherein each feed line includes a feed control unit configured for adjustably controlled feeding of a carrier gas and of a respective at least one material component of the connecting material.

5. The device of claim 1, wherein at least one heat sink is provided to the conductor at the section to be joined or at the positioning unit.

6. The device of claim 1, wherein, preceding or following the at least one first plasma source in a direction of advance, at least one second plasma source is provided.

7. A device for joining a conductor to a substrate, comprising:
a positioning unit for positioning the conductor with a section to be joined;
at least one first plasma source for generating a plasma; wherein the at least one first plasma source is directed onto the section to be joined for providing a first disposal of an activated connecting material to the section to be joined; and,
at least one second plasma source arranged downstream to the least one first plasma source, wherein the at least one second plasma source is directed onto the section to be joined, so that a second disposal of a second connecting material is deposited onto the first disposal of the activated connecting material.

8. The device of claim 7, further comprising:
at least one first feed line for the at least one first plasma source; and,
at least one second feed line for the at least one second plasma source;
wherein each of the at least one first and second feed lines feed a first connecting material into the plasma of the at least one first plasma source and the least one second plasma source, respectively.

9. A device for joining a conductor to a substrate, comprising:
a positioning unit for positioning the conductor with a first section to be joined;
at least one first plasma source for generating a plasma; wherein the first plasma source is directed onto the first section to be joined for providing a first disposal of an activated connecting material to the first section to be joined; and,
at least one second plasma source arranged downstream and at a distance to the least one first plasma source, wherein the at least one second plasma source is directed onto a second section to be joined, so that a second disposal of a second connecting material is deposited on the first disposal of the activated connecting material provided by the at least one first plasma source.

10. The device of claim 9, further comprising:
at least one first feed line for the at least one first plasma source; and,
at least one second feed line for the at least one second plasma source;
wherein each of the at least one first and second feed lines feed a third connecting material into the plasma of the at least one first plasma source and the least one second plasma source, respectively.

11. A method for joining a conductor to a substrate, comprising the steps of:
positioning the conductor with a section to be joined on a substrate with a positioning unit;
generating a plasma in at least one first plasma source and feeding a first connecting material into the plasma, wherein the first connecting material is activated by at least partially changing its state;
directing a plasma jet and the activated connecting material contained therein through at least one nozzle of the at least one first plasma source onto the section to be joined; and,
depositing the activated connecting material on the section to be joined, so that a first disposal of the activated connecting material joins the conductor with the substrate by a bonded connection.

12. The method of claim 11, wherein a relative motion between the section to be joined and the at least one first plasma source is performed along a joining path on the substrate.

13. The method of claim 11, wherein the first connecting material fed to the at least one first plasma source is composed of a plurality of material components.

14. The method of claim 13, wherein:
each of the plurality of material components has a mixing ratio; and,
the plurality of material components and their mixing ratios are varied.

15. The method of claim 11, wherein, following the at least one first plasma source in a direction of advance, at least one second plasma source is provided, by which a second disposal of a second connecting material is applied at least in part of an area together with the first disposal or on the first disposal.

16. The method of claim 11, wherein a heat sink is provided at the section to be joined, or is connected with the conductor in a thermally conductive manner by the positioning unit, so that heat energy is withdrawn from the conductor.

17. The method of claim 11, wherein the positioning unit sets a pressure force on the conductor against the substrate and/or a drag force on the conductor in a direction of advance.

18. The method of claim 11, wherein the first connecting material includes at least one type of powder which is mixed and homogenized with a carrier gas or a carrier liquid.

19. A method for joining a conductor to a substrate, comprising the steps of:
positioning the conductor with a section to be joined on a substrate by a positioning unit;
generating a first plasma in at least one first plasma source and feeding a first connecting material into the first plasma, wherein the first connecting material is activated into a first activated connecting material by at least partially changing its state;
directing a first plasma jet and the first activated connecting material contained therein through at least one first nozzle of the at least one first plasma source onto the section to be joined;
generating a second plasma in at least one second plasma source and feeding a second connecting material into the second plasma, wherein the second connecting material is activated into a second activated connecting material by at least partially changing its state;
directing a second plasma jet and the second activated connecting material contained therein through at least one second nozzle of the at least one second plasma source onto the section to be joined; and,
depositing the activated connecting materials from the at least one first and second plasma sources on the section to be joined, so that a disposal of the activated connecting materials joins the conductor with the substrate by a bonded connection.
